(19) United States
(12) Patent Application Publication
(10) Pub. No.: US 2021/0408646 A1
(43) Pub. Date: Dec. 30, 2021

(54) BATTERY COMPRISING ELECTRODE WITH LASER-SINTERED MATERIAL AND SHINGLE FACE-TO-FACE OVERLAPS WITHIN END PLATE

(71) Applicant: James E. Beecham, West Palm Beach, FL (US)

(72) Inventor: James E. Beecham, West Palm Beach, FL (US)

(21) Appl. No.: 17/468,534

(22) Filed: Sep. 7, 2021

Related U.S. Application Data
(62) Division of application No. 17/241,438, filed on Apr. 27, 2021.
Application No. 17/241,438 is a division of application No. 17/114,222, filed on Dec. 7, 2020.
Application No. 17/114,222 is a continuation-in-part of application No. 17/108,969, filed on Dec. 1, 2020.
Application No. 17/108,969 is a continuation-in-part of application No. 17/102,226, filed on Nov. 23, 2020.
Application No. 17/102,226 is a continuation-in-part of application No. 17/092,035, filed on Nov. 6, 2020, now abandoned.
Application No. 17/092,035 is a continuation-in-part of application No. 17/064,243, filed on Oct. 6, 2020, now abandoned.
Application No. 17/064,243 is a continuation-in-part of application No. 17/033,853, filed on Sep. 27, 2020, now abandoned.
Application No. 17/102,226 is a continuation-in-part of application No. 16/867,273, filed on May 5, 2020, now Pat. No. 10,800,434.
(60) Provisional application No. 62/986,682, filed on Mar. 7, 2020.

(51) Int. Cl. H01M 50/533; H01M 50/538

(52) U.S. Cl. CPC H01M 50/533; H01M 50/538

(57) ABSTRACT

Instant invention comprises an electrode configured with laser-sintered coating materials, said electrode further comprised of at least one hundred extensions. Said electrode comprises a jelly roll of battery materials wherein an end plate in wound jelly roll comprises said at least one hundred extensions in shingle-style overlaps to extensions of same electrode. A battery comprised of said jelly roll of battery materials comprises improved capacity due to laser sintering, and further comprises improved useful life by large area of electrical connections to external circuit enabled by said electrode extensions configured in end plate as shingle-style overlaps. In a preferred embodiment, laser-sintered materials comprise in anode, selection from a group consisting of Li, C, Si, Mg, Cu, Ni, Al, Ti, Sn and the arbitrary combinations thereof; and in cathode, selection from a group consisting of lithium-cobalt-based composites, LiFePO.sub.4-based composites, lithium LiMnPO.sub.4-based composites, lithium-manganese-based composites, lithium-nickel-based composites, lithium-cobalt-nickel-manganese-based composites, and the arbitrary combinations thereof.

### CROSS-REFERENCE TO RELATED APPLICATION

The present invention is a divisional application to non-provisional application Ser. No. 17/241,438 filed 27 Apr. 2021 which is a divisional application to non-provisional application Ser. No. 17/114,222 filed 7 Dec. 2020 entitled “BATTERY COMPRISING ELECTRODE WITH LASER-SINTERED MATERIAL AND AT LEAST ONE HUNDRED ELECTRODE EXTENSIONS” which claims priority to non-provisional application Ser. No. 17/108,969 filed 1 Dec. 2020 by instant inventor, entitled STARWHEEL-ENABLED ASSEMBLING OF LONG-LIFE BATTERIES, which claims priority to non-provisional application Ser. No. 17/102,226 filed 23 Nov. 2020 by instant inventor, entitled CONFIGURING AND MAINTAINING SHINGLED OVERLAPS OF ELECTRODE EXTENSIONS AT END PLATE OF JELLY ROLL OF BATTERY MATERIALS, which claims priority to non-provisional application Ser. No. 17/092,035 filed 6 Nov. 2020 by instant inventor, entitled ELECTRODE EXTENSION OVERLAP CONFIGURATIONS IN BATTERY, which claims priority to non-provisional application Ser. No. 17/064,243 filed 6 Oct. 2020 by instant inventor, entitled ELECTRIC VEHICLE BATTERY PACKS COMPRISING TABLES/MULTI-TAB CYLINDRICAL JELLY-ROLL STYLE BATTERY CELLS, which claims priority to non-provisional application Ser. No. 17/033,853 filed 27 Sep. 2020 by instant inventor, entitled ELECTRIC VEHICLE SAFETY AS TO SIDE COLLISIONS AND BATTERY PACK PLACEMENT IN MANUFACTURING, which claims priority to non-provisional application Ser. No. 16/867,273 filed 5 May 2020 by instant inventor, entitled A METHOD AND SYSTEM FOR MITIGATING ANTICIPATED RISKS IN SELF-DRIVING VEHICLES VIA USE OF MALICIOUS ROADWAY FALSIFIED APPEARANCES now issued U.S. Pat. No. 10,800,434 of 13 Oct. 2020, which claims priority to provisional application Ser. No. 62/298,6682 filed Mar. 7, 2020, hereby each referenced publication is incorporated in its entirety at least by reference.

### 1. FIELD OF THE INVENTION

The present invention generally relates to battery electrode. More specifically, the present invention relates to battery comprising electrode comprising laser-sintered material and electrode extensions.

### BRIEF SUMMARY OF THE INVENTION

In a preferred embodiment, instant invention comprises a battery comprising wound jelly roll of battery materials, said jelly roll comprising at least one electrode comprising laser-sintered material and at least one hundred extensions. In a preferred embodiment, said laser-sintered material comprises metal selected from a group consisting of Ti, Au, Ag, Fe, Al, Cu, and the combinations thereof.

The term ‘laser sintering’ herein is defined as sintering or melting using a focused beam of energy, such as a laser beam, an electron beam, an arc energy, or the arbitrary combinations thereof. The term ‘arbitrary combinations’ is defined and used herein as it was used in U.S. patent Ser. No. 10/644,305, said publication included herein in its entirety, at least by reference. The following two paragraphs, each adapted from said patent publication U.S. Ser. No. 10/644,305, assist by context in understanding the use herein of the term ‘arbitrary combinations’:
(adapted for explanatory purposes from U.S. Ser. No. 10/644,305) . . . the patterned conductive layer can be formed by following steps: A conductive powder (including metal materials, such titanium (Ti), gold (Au), silver (Ag), iron (Fe), Al, Cu or the alloys constituted by the arbitrary combinations thereof) is provided to cover on the surface of the substrate. A focused beam of energy, such as a laser beam, an electron beam, an arc energy, or the arbitrary combinations thereof is directed to the surface of the substrate for sintering or melting the conductive powder.
(adapted for explanatory purposes from U.S. Ser. No. 10/644,305) . . . For example, the active particles can be porous Si—C ceramic particles, Si—C—Cu ceramic particles, Si—Cu ceramic particles, Mg/Ni/Si ceramic particles, Mg/Ni alloy particles, or the arbitrary combinations thereof.

In a preferred embodiment of instant invention, said laser sintering is carried out as is well-known in the art. In a preferred embodiment, said laser-sintered materials comprise active particles comprising an anode, said material selected from a group consisting of Li, C, Si, Mg, Cu, Ni, Al, Ti, Sn and the arbitrary combinations thereof. In a preferred embodiment, said laser-sintered materials comprise active particles comprising a cathode, said material selected from a group consisting of lithium-cobalt-based composites, LiFePO.sub.4-based composites, lithium LiMnPO.sub.4-based composites, lithium-manganese-based composites, lithium-nickel-based composites, lithium-cobalt-nickel-manganese-based composites, and the arbitrary combinations thereof.

In a preferred embodiment, said jelly roll of battery materials comprises at least one jelly roll comprised by winding of an end plate comprised of shingle-style overlaps of electrode extensions of said electrode comprising laser-sintered material. In a preferred embodiment, said laser-sintered material and said end plate of overlapped electrode extensions mutually promote safe and efficient battery performance for said battery comprised of said electrode.

In a preferred embodiment, at least one electrode comprises both laser-sintered material and at least one hundred extensions of electrode. In a preferred embodiment, said extensions comprise overlaps located at end plate, said overlaps comprising shingle-style face-to-face overlaps. Said overlaps, when connecting battery and external circuit, comprise multiple electron paths enabling electrode to electrically connect to external circuit and carry electrons. Said electrons comprise those electrons interacting to laser-sintered materials.

In a preferred embodiment, said electrode extensions are wound into face-to-face overlaps of shingle style when jelly roll of battery materials undergoes winding. In a preferred embodiment, each of top and bottom end of said jelly roll comprises same style of end plate, comprised of overlaps of electrode extensions. In a preferred embodiment, at least one of top and bottom end plates comprises tabs which secure said end plates against unraveling. In a preferred embodiment, said securing tabs number at least ten per said at least one end plate.

In a preferred embodiment, said face-to-face shingle-style electrode extension overlaps comprise at least a majority of the said end plate's volume. In a preferred embodiment, said securing tabs are folded over at least a portion of the tab-adjacent periphery of the said end plate. In a preferred embodiment, said tabs tab folded over at least a portion of end plate secure integrity of electron paths to external circuit. In a preferred embodiment, said tabs arise from one of list: battery case, battery jacket, band applied to battery, clip applied to battery at end plate.

In a preferred embodiment, said laser-sintered materials comprise metal selected from a group consisting of Ti, Au, Ag, Fe, Al, Cu, and the combinations thereof. In a preferred embodiment, said laser-sintered materials comprise active particles comprising magnesium (Mg)/nickel (Ni) alloy. In a preferred embodiment, said laser-sintered materials comprise active particles comprising an anode, said material selected from a group consisting of Li, C, Si, Mg, Cu, Ni, Al, Ti, Sn and the arbitrary combinations thereof.

In a preferred embodiment, said mutual enabling of laser-sintered materials and electrode extensions allows adequate power to external circuit while avoiding production within battery of dangerous areas of overheating. In a preferred embodiment, said avoiding of overheating protects against fire from battery.

The following publications are herein incorporated in their entirety, at least by reference: U.S. Pat. No. 10,644,305 to Huang et al, regards laser sintering of metals of electrode.

### BRIEF DESCRIPTION OF THE FIGURES

Other features and advantages of the present invention will become apparent when the following detailed description is read in conjunction with the accompanying drawings, in which:

FIG. 1 is a schematic illustrating details of a preferred embodiment.

FIG. 2 is a schematic illustrating details of a preferred embodiment.

### DETAILED DESCRIPTION OF PREFERRED EMBODIMENTS

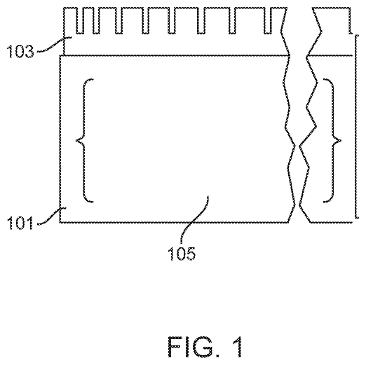

In FIG. 1, a preferred embodiment of instant invention is illustrated wherein an electrode 101 is illustrated with dividing line to indicate a longer electrode is typical for instant invention. It is understood that electrode comprises a plurality of electrode extensions 103. The divided electrode schematic comprises in illustration ten extensions, which are understood to represent the at least 100 extensions of typical electrode of instant invention.

A layer of materials 105 is present on lower aspect of said electrode 101. Said materials coat electrode 101 and are subjected, during manufacture, to laser sintering, as is well known in the art (please refer to U.S. Pat. No. 10,644,305 cited above for details).

It is understood that after sintering, jelly roll is assembled and wound about a central axis in manner well known in the art. It is understood that jelly roll is comprised after winding, into battery case. It is understood that battery case is attached to external circuit in the standard manner. Said battery, in service, is understood to provide power via electrical connection to an external circuit. It is understood that active materials in the battery enable the said providing of power.

In a preferred embodiment, said laser-sintered material comprises metal selected from a group consisting of Ti, Au, Ag, Fe, Al, Cu, and the combinations thereof. In a preferred embodiment, said laser-sintered materials comprise active particles comprising an anode, said material selected from a group consisting of Li, C, Si, Mg, Cu, Ni, Al, Ti, Sn and the arbitrary combinations thereof. In a preferred embodiment, active particles comprise a cathode material selected from a group consisting of lithium-cobalt-based composites, LiFePO.sub.4-based composites, lithium LiMnPO.sub.4-based composites, lithium-manganese-based composites, lithium-nickel-based composites, lithium-cobalt-nickel-manganese-based composites, and the arbitrary combinations thereof.

In a preferred embodiment, the battery comprised of instant invention electrode is simultaneously enabled when in service to external circuit, to improved charge capacity and improved electrical connection to external circuit. It is understood that the capacity is improved by sintered materials, and that the electrical connection is improved by the electrode extensions in overlap. It is understood that together, these factors mutually reinforce the performance factors of the battery.

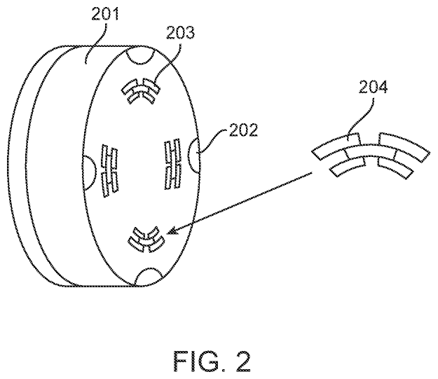

In FIG. 2, a preferred embodiment of instant invention is illustrated wherein an end plate 201 of jelly roll of battery materials is shown. Said jelly roll is understood to comprise at least one electrode which comprises laser-sintered materials. Said jelly roll further comprises a plurality of electrode extensions to comprise said laser-sintered-materials-comprised electrode.

Ends of electrode extensions 201 are shown in 4 groups of overlapped extensions across the expanse of the end plate, viewed in perspective from above side of jelly roll. It is understood that each extension of electrode comprises a front face and a back face. It is understood that in FIG. 2, top edges of overlapped electrode extensions are viewed in top/side of jelly roll perspective view.

The extensions of this electrode of jelly roll here wound and in perspective view of end plate number one hundred or more in instant invention. But per this schematic, the one hundred or more extensions are represented by said 4 groups at 203. The details of tight overlap of face of one extension shingle-overlapped onto face of adjacent extension are shown 204.

The tabs 202 are typically disposed as a plurality of tabs all around the periphery of the end plate, but here the full periphery of tabs is represented by 4 tabs. The tabs secure said end plate against unraveling. The extensions of electrode are closely approximated, within the battery case, during battery operations, thus enabling secure electrical connection to external circuit.

The enablement to safe, efficient operations and longer useful battery life comprised by laser-sintered material disclosed herein is mutual reinforcing to that benefit derived from the secure electrical connections enabled by the electrode extensions as end plate configured.

The mutual benefits of laser sintering of electrode materials and overlaps of electrode extensions comprise the following: Due to the laser sintering, the active particles can be more tightly engaged with the conductive layer, thus the capacity of battery to hold a charge is improved. Meanwhile, such increased charge capacity is more efficiently shared as smoothly delivered power to the needs of the external circuit, such smooth delivery of power enabled by battery use of secure electrical connections comprised as multiple electron paths provided by overlapped extensions of the electrode at the end plate.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A cylindrical battery comprising an end plate wherein a first electrode comprises a plurality of face-to-face shingle style overlaps comprising a plurality of said first electrode's extensions, and wherein said plurality of said overlapped extensions comprise at least one group comprised of a central element comprising an extension of said first electrode, and onto said central element are overlapped at least three surrounding extensions of said same electrode comprising shingle-style face-to-face overlaps onto central element.

2. The battery end plate of claim 1, further comprising at least two such groups disclosed in claim 1, each group comprised of a central element comprising an extension of said first electrode, and onto said each respective central element are respectively overlapped at least three surrounding extensions of said same electrode comprising shingle-style face-to-face overlaps of respective surrounding extensions onto respective central element.

3. The battery end plate of claim 2, further comprising at least one further group comprising a central element comprising an extension of said first electrode, said at least one further group's central element comprising at least four surrounding electrode extensions of said first electrode, said surrounding at least four electrode extensions comprising overlaps respectively applied shingle-style onto said at least one further group's central element in face-to-face manner.

4. The battery end plate of claim 3, further comprising at least two such groups disclosed in claim 3, each group comprised of a central element comprising an extension of said first electrode, and onto said each respective central element are respectively overlapped at least four surrounding extensions of said same electrode comprising shingle-style face-to-face overlaps of respective surrounding extensions onto respective central element.
